(19) United States
(12) Patent Application Publication
(10) Pub. No.: US 2019/0004633 A1
(43) Pub. Date: Jan. 3, 2019

(54) TOUCH PANEL DEVICE AND PROCESS METHOD FOR TOUCH PANEL DEVICE

(71) Applicant: OLYMPUS CORPORATION, Tokyo (JP)

(72) Inventors: Taiji Uchida, Tokyo (JP); Hiroyuki Ushifusa, Tokyo (JP)

(73) Assignee: OLYMPUS CORPORATION, Tokyo (JP)

(21) Appl. No.: 16/122,285

(22) Filed: Sep. 5, 2018

Related U.S. Application Data
(63) Continuation of application No. PCT/JP2016/082165, filed on Oct. 28, 2016.

(30) Foreign Application Priority Data
Mar. 15, 2016 (JP) 2016-050959

(51) Int. Cl. G06F 3/044; G06F 3/0482; G06F 3/041; G06F 3/0488

(52) U.S. Cl. CPC G06F 3/044; G06F 3/0488; G06F 3/0412; G06F 3/0482

(57) ABSTRACT

A touch panel device includes a capacitance touch panel, a calibration performing unit configured to perform a first calibration process for adjusting a reference potential, which serves as a detection threshold for a touch manipulation on the touch panel, after a power source starts power supply, a touch manipulation detection unit configured to become able to detect a touch manipulation on the touch panel after the first calibration process is completed, and a touch manipulation monitoring unit configured to monitor detection of a touch manipulation in the touch manipulation detection unit after the first calibration process is completed, and to instruct the calibration performing unit to perform a second calibration process for adjusting the reference potential, when the touch manipulation detection unit detects a first touch manipulation.

### CROSS-REFERENCE TO RELATED APPLICATIONS

This application is based upon and claims the benefit of priority of the prior Japanese Patent Application No. 2016-050959, filed Mar. 15, 2016, the entire contents of which are incorporated herein by reference.

This is a Continuation Application of PCT Application No. PCT/JP2016/082165, filed Oct. 28, 2016, which was not published under PCT Article 21(2) in English.

### FIELD

The present invention is related to a touch panel device provided with a capacitance touch panel, and a process method for such a touch panel device.

### BACKGROUND

Capacitance touch panels have conventionally been known to have the touch panel sensitivity varying in response to changes etc. in the ambient environment such as for example a temperature. Because of this, for example the turning on or activation of a touch panel device provided with a capacitance touch panel is accompanied by a calibration process for calibrating the sensitivity of the touch panel. This calibration process involves various processes including the adjustment of the reference potential, which serves as a threshold for detecting a touch manipulation on the touch panel.

While a calibration process is designed to be performed with the touch panel in a contactless state, in which nothing is in contact with the touch panel, the calibration process may sometimes be performed with the touch panel in a state in which the user's hand etc. is in contact with the touch panel.

A calibration method is known, in which a non-contact area, in which no contact is detected, is calibrated by using an output value of the non-contact area included in the area of the touch panel during the calibration process and a contact-detected area, in which contact is detected, is calibrated by using an output value of a non-contact area adjacent to the contact-detected area during the calibration process (see Japanese Laid-open Patent Publication No. 2015-153394).

### SUMMARY

One aspect of the present invention provides a touch panel device including a capacitance touch panel, a calibration performing unit configured to perform a first calibration process for adjusting a reference potential, which serves as a detection threshold for a touch manipulation on the touch panel, after a power source starts power supply, a touch manipulation detection unit configured to become able to detect a touch manipulation on the touch panel after the first calibration process is completed, and a touch manipulation monitoring unit configured to monitor detection of a touch manipulation in the touch manipulation detection unit after the first calibration process is completed, and to instruct the calibration performing unit to perform a second calibration process for adjusting the reference potential, when the touch manipulation detection unit detects a first touch manipulation, wherein the calibration performing unit performs the second calibration process in accordance with the instruction of the touch manipulation monitoring unit.

Another aspect of the present invention provides a process method for a touch panel device including a capacitance touch panel, the process method including performing a first calibration process for adjusting a reference potential, which serves as a detection threshold for a touch manipulation on the touch panel, after a power source starts power supply, and monitoring detection of a touch manipulation after the first calibration process is completed, and performing a second calibration process for adjusting the reference potential for the touch panel when a first touch manipulation is detected on the touch panel.

### BRIEF DESCRIPTION OF DRAWINGS

FIG. 1 illustrates a configuration example of an endoscope system to which a touch panel device of an embodiment is applied;

FIG. 2 is a flowchart explaining an example of the activation operation of a video processor;

FIG. 3 illustrates an example of the state of a user's hand with respect to a touch panel, a window example of a display unit of the touch panel, and a window example of a monitor;

FIG. 4 illustrates another example of the state of a user's hand with respect to the touch panel and a window example of the display unit of the touch panel; and

FIG. 5 illustrates a window example of the display unit of the touch panel.

### DESCRIPTION OF EMBODIMENTS

Explanations will be hereinafter given for the embodiments of the present invention by referring to the drawings.

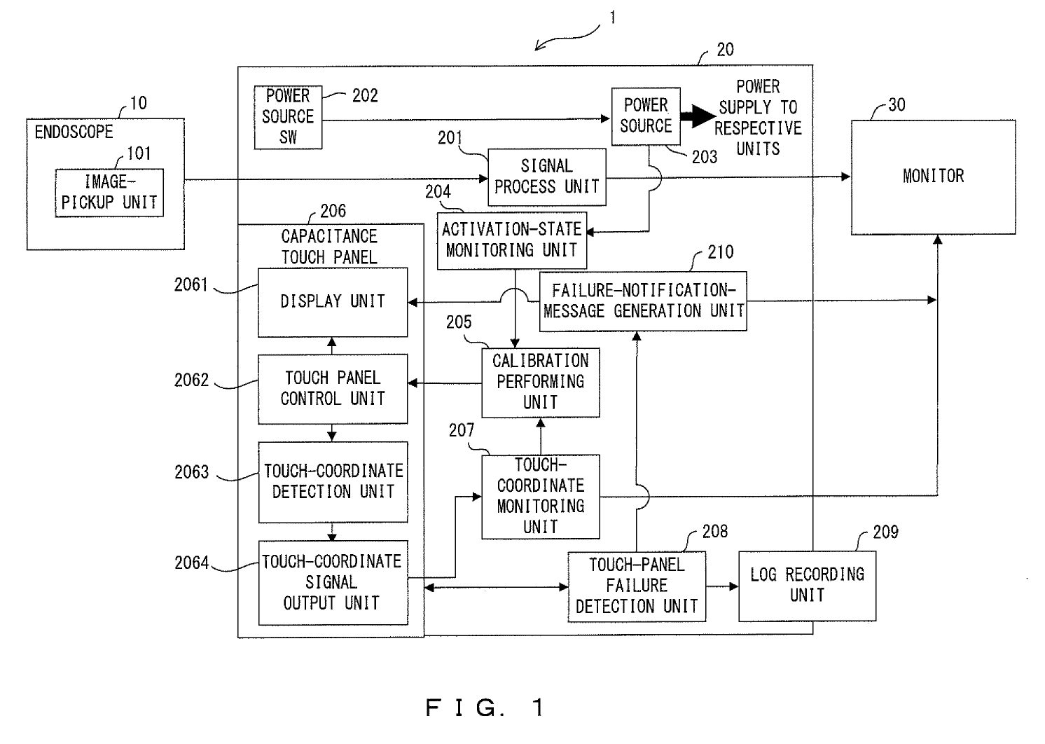

FIG. 1 illustrates a configuration example of an endoscope system to which the touch panel device of an embodiment of the present invention is applied. This endoscope system is a system used for various purposes including endoscopic examinations conducted in a medical facility. An example of a medical facility is a hospital.

As illustrated in FIG. 1, an endoscope system 1 includes an endoscope 10, a video processor 20, and a monitor 30, with the endoscope 10 and the monitor 30 connected to the video processor 20.

The endoscope 10 includes an image-pickup unit 101 for picking up an image of the inside of the patient's cavity, and outputs, to the video processor 20, an image signal obtained through the picking up by the image-pickup unit 101. Note that a camera head provided with an image-pickup unit instead of the endoscope 10 may be applied.

The video processor 20 includes a signal process unit 201, a power source SW (switch) 202, a power source 203, an activation-state monitoring unit 204, a calibration performing unit 205, a capacitance touch panel 206, a touch-coordinate monitoring unit 207, a touch-panel failure detection unit 208, a log recording unit 209, and a failure-notification-message generation unit 210. The video processor 20 is also a signal processing device.

The signal process unit 201 processes an image signal input from the endoscope 10 so as to generate a video signal, and outputs the video signal to the monitor 30.

The power source SW 202 turns on and off the power source 203 of the video processor 20.

In accordance with a manipulation that the user conducts on the power source SW 202, the power source 203 starts or stops power supply to the units of the video processor 20 and to the endoscope 10 and the monitor 30 that are connected to the video processor 20. Specifically, the power source 203 starts power supply in response to a manipulation of the power source SW 202 to turn on the power source 203 and stops the power supply in response to a manipulation of the power source SW 202 to turn off the power source 203.

The activation-state monitoring unit 204 monitors the starting or stopping of the power supply performed by the power source 203, and thereby monitors the activation state of the video processor 20. For example, the activation-state monitoring unit 204 detects the activation of the video processor 20 in response to the detection of the power source 203 starting power supply, and gives a calibration performing instruction to the calibration performing unit 205.

In accordance with the calibration performing instruction from the activation-state monitoring unit 204 or the touch-coordinate monitoring unit 207, the calibration performing unit 205 performs a calibration process for calibrating the sensitivity of the touch panel 206. This calibration process involves various processes including the adjustment of the reference potential, which serves as a threshold for detecting a touch manipulation on the touch panel 206.

The touch panel 206 includes a display unit 2061, a touch panel control unit 2062, a touch-coordinate detection unit 2063, and a touch-coordinate signal output unit 2064.

The display unit 2061 is for example a Liquid Crystal Display (LCD), and displays various types of manipulation windows, a message, etc. For example, a menu window, a failure-notification message, etc. are displayed as a manipulation window, a message, etc.

The touch panel control unit 2062 controls the touch panel 206. For example, the touch panel control unit 2062 controls the touch panel 206 in accordance with a calibration process performed by the calibration performing unit 205.

The touch-coordinate detection unit 2063 detects the coordinates of the touch manipulation on the touch panel 206.

The touch-coordinate signal output unit 2064 outputs a touch-manipulation coordinate signal to the touch-coordinate monitoring unit 207, the touch-manipulation coordinate signal representing the touch-manipulation coordinate detected by the touch-coordinate detection unit 2063.

The touch-coordinate monitoring unit 207 monitors the touch-manipulation coordinate signal input from the touch-coordinate signal output unit 2064. For example, the touch-coordinate monitoring unit 207 notifies the user to conduct a reactivation manipulation of the video processor 20 when detecting a touch-manipulation coordinate signal from the touch-coordinate signal output unit 2064 after the calibration performing unit 205 performs a calibration process in accordance with a calibration performing instruction from the activation-state monitoring unit 204 and before reception of a touch manipulation on the touch panel 206 starts. Also, the touch-coordinate monitoring unit 207 for example gives a calibration performing instruction to the calibration performing unit 205 when detecting the first touch-manipulation coordinate signal from the touch-coordinate signal output unit 2064 after the calibration performing unit 205 performs a calibration process in accordance with a calibration performing instruction from the activation-state monitoring unit 204 and after reception of a touch manipulation on the touch panel 206 starts. Note that “before reception of a touch manipulation on the touch panel 206 starts” means for example before the first manipulation window to be displayed in the display unit 2061 is displayed after the start of the activation of the video processor 20. Hereinbelow, the first manipulation window to be displayed will be referred to as an “initial-menu window”. Also, “after reception of a touch manipulation on the touch panel 206 starts” means for example after the initial-menu window is displayed in the display unit 2061. “Notifying the user to conduct a reactivation manipulation of the video processor 20” is for example a message, on the monitor 30, that prompts the user to again turn on the power source SW 202 of the video processor 20. “Again turn on the power source SW 202” is to manipulate the power source SW 202 to turn off and on the power source 203 of the video processor 20.

The touch-panel failure detection unit 208 detects failure of the touch panel 206. For example, the touch-panel failure detection unit 208 periodically conducts communications with the touch panel 206, and, when the communication is not successful, reports that fact to the failure-notification-message generation unit 210 and also records it as a log in the log recording unit 209. Also, for example, the touch-panel failure detection unit 208 obtains a self-check result from the touch panel 206 upon the activation of the video processor 20. And when that self-check result indicates failure of the touch panel 206 such as for example sensor failure of the touch panel 206, the touch-panel failure detection unit 208 reports that fact to the failure-notification-message generation unit 210 and also records it as a log in the log recording unit 209. Note that the touch panel 206 has a self-checking function of checking the state of itself upon the activation. An example of the state of itself is a state such as for example the presence or absence of sensor failure.

The log recording unit 209 records, as a log, the contents of the report from the touch-panel failure detection unit 208. The contents of communications from the touch-panel failure detection unit 208 are contents of failure of the touch panel 206 such as an unsuccessful communication, sensor failure, etc. The log recording unit 209 is for example a portable recording medium that is detachable from the video processor 20, such as a Universal Serial Bus (USB) memory etc.

In response to the report from the touch-panel failure detection unit 208, the failure-notification-message generation unit 210 generates a failure-notification message for notifying the user of the failure type of the touch panel 206 such as an unsuccessful communication, sensor failure, etc. And it outputs the generated failure-notification message to the display unit 2061 and the monitor 30. Thereby, the display unit 2061 and the monitor 30 display the failure-notification message.

The monitor 30 is for example an LCD, and displays a video in response to a video signal input from the video processor 20 and various types of information such as a message. For example, a message such as a message prompting the user to perform a reactivation manipulation and a failure-notification message is displayed.

A circuit may implement each of the units in the video processor 20 such as for example the signal process unit 201, the activation-state monitoring unit 204, the calibration performing unit 205, the touch panel control unit 2062, the touch-coordinate detection unit 2063, the touch-coordinate signal output unit 2064, the touch-coordinate monitoring unit 207, the touch-panel failure detection unit 208, and the failure-notification-message generation unit 210. In such a case, each unit may be implemented by for example an integrated circuit such as for example an ASIC (Application Specific Integrated Circuit) or an FPGA (Field-Programmable Gate Array). Alternatively, for example the video processor 20 may be provided with a processor such as a CPU (Central Processing Unit) and a memory, and the processor executes a program stored in the memory so as to implement each unit.

Next, the operations of the endoscope system 1 will be explained.

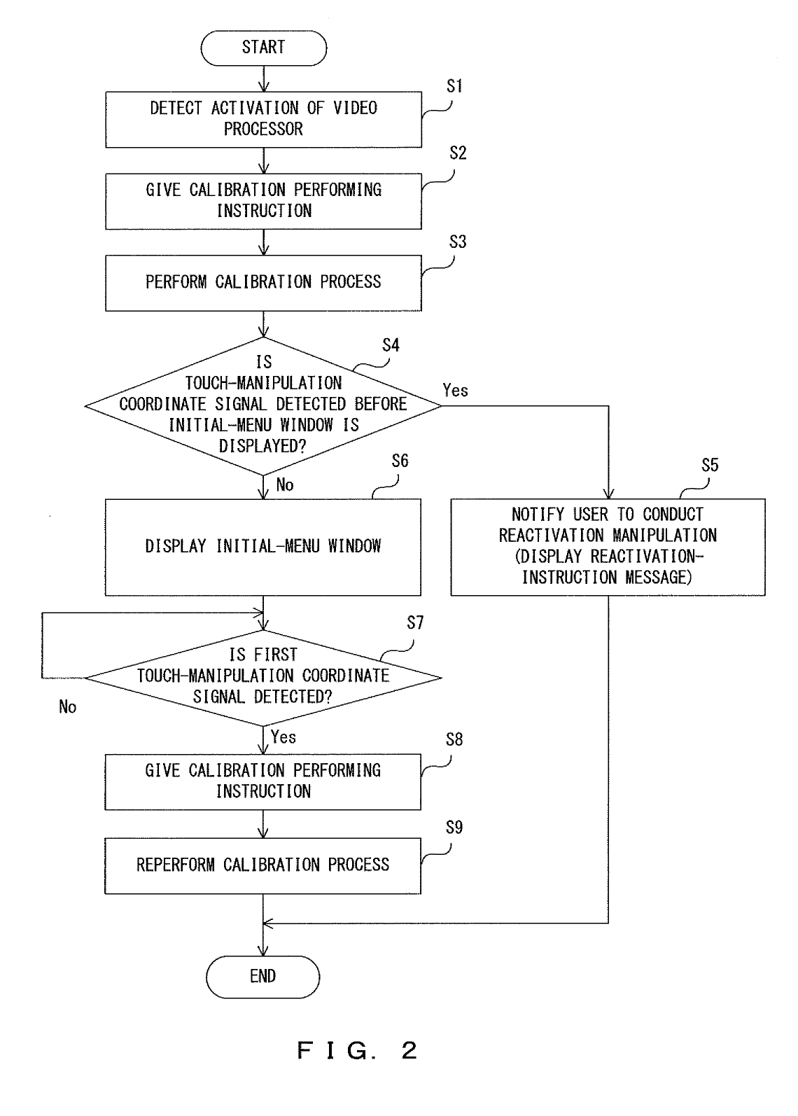

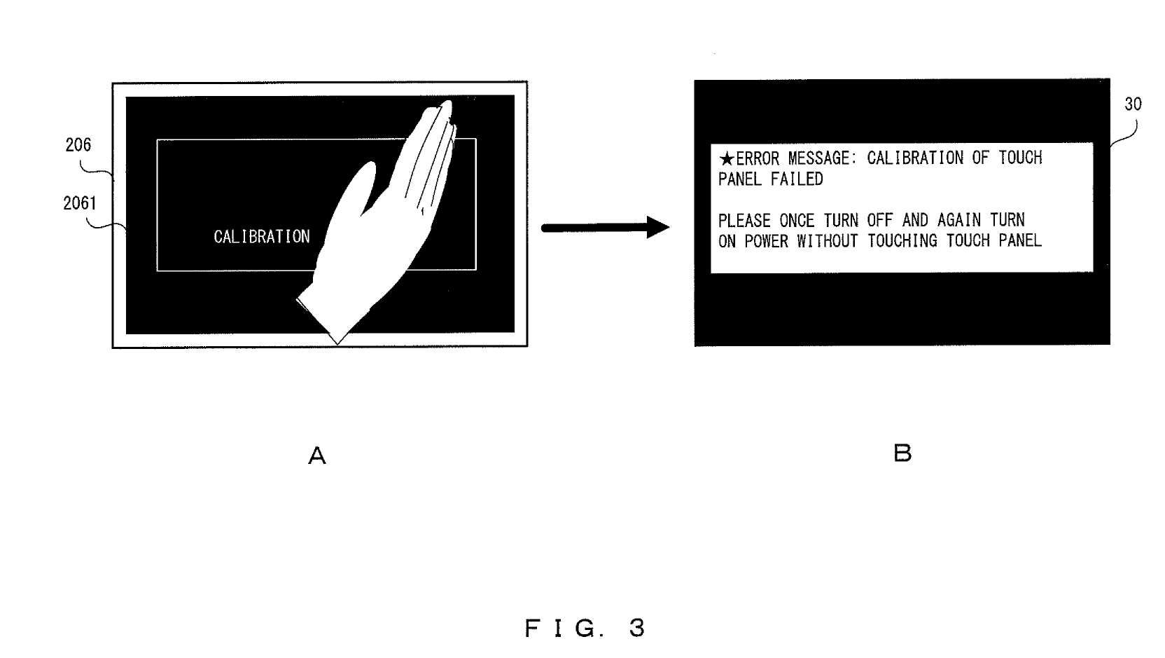

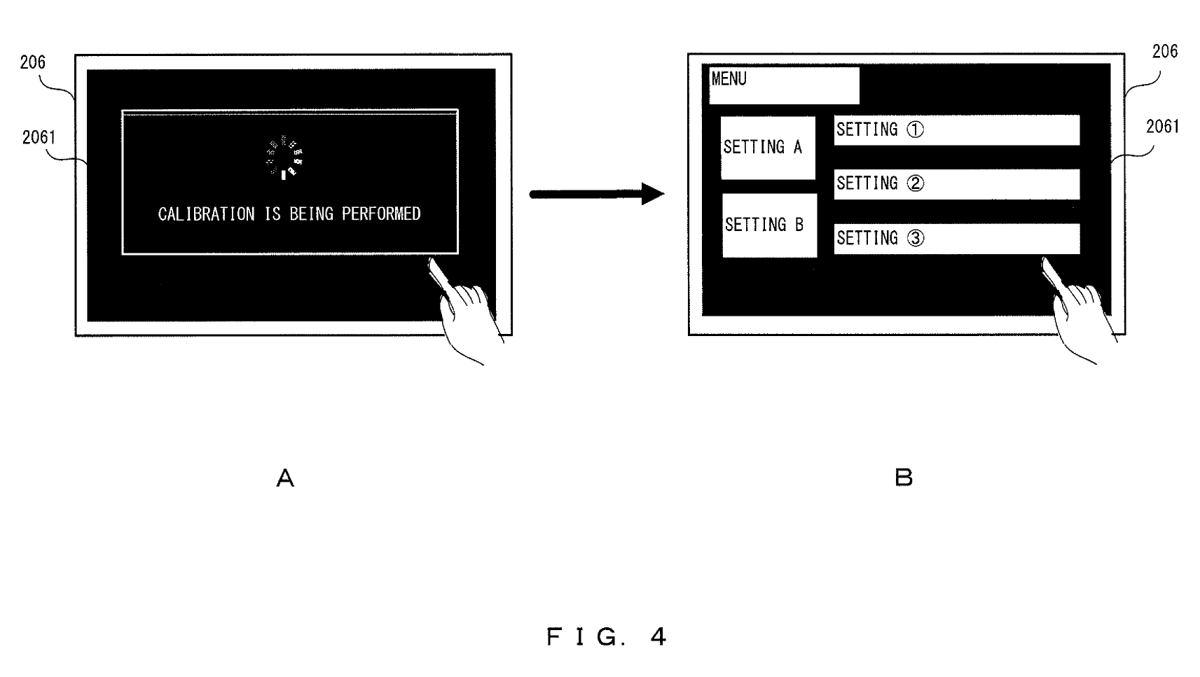

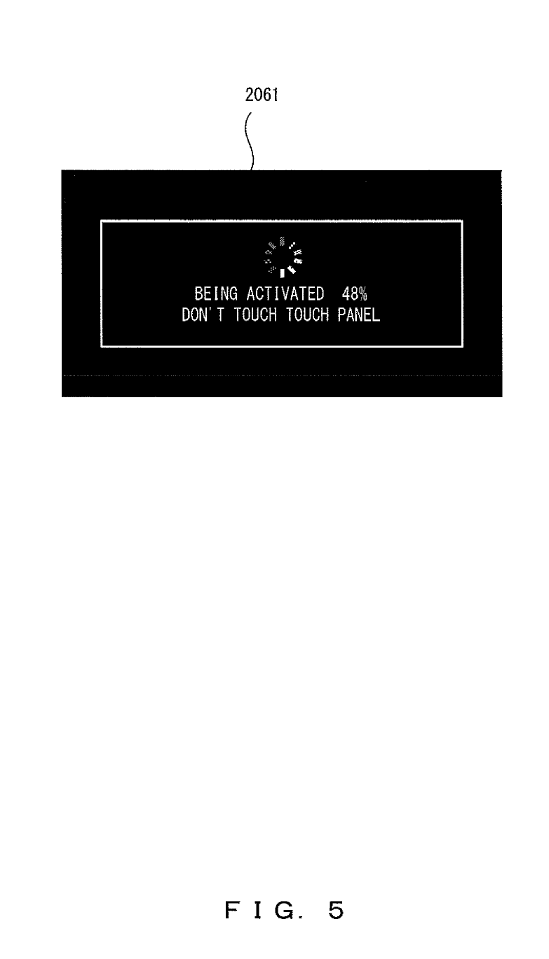

FIG. 2 is a flowchart explaining an example of the activation operation of the video processor 20, which is also the activation operation of the endoscope system 1. FIG. 3 illustrates an example of the state of a user's hand with respect to the touch panel 206, a window example of the display unit 2061, and a window example of the monitor 30. FIG. 4 illustrates another example of the state of a user's hand with respect to the touch panel 206, and a window example of the display unit 2061. FIG. 5 illustrates a window example of the display unit 2061.

As illustrated in FIG. 2, when the power source 203 is turned on in response to the user manipulating the power source SW 202 and the power source 203 starts supplying power, the activation-state monitoring unit 204 detects the activation of the video processor 20 (S1), and gives a calibration performing instruction to the calibration performing unit 205 (S2).

In response to the calibration performing instruction of S2, the calibration performing unit 205 performs a calibration process (S3).

Upon the termination of the calibration process, the touch-coordinate monitoring unit 207 determines whether or not a touch-manipulation coordinate signal from the touch-coordinate signal output unit 2064 has been detected after that calibration process is terminated and before the initial-menu window is displayed in the display unit 2061 (S4). Note that the initial-menu window is displayed in the display unit 2061 when for example a prescribed period of time has elapsed after the termination of a calibration process.

When the determination result is YES in S4, the touch-coordinate monitoring unit 207 notifies the user to conduct a reactivation manipulation of the video processor 20 (S5).

The processes in S4 and S5 are performed for the following reasons. In some cases, the calibration process of S3 is performed with the display unit 2061 of the touch panel 206 touched by a user's hand as illustrated in A of FIG. 3, and thereafter the user's hand ceases to touch the touch panel 206 before the initial-menu window is displayed in the display unit 2061. In such a case, the touch-coordinate detection unit 2063 detects, as touch-manipulation coordinates, the coordinates of the portion that the user's hand was touching, after the user's hand ceases to touch the touch panel and before the initial-menu window is displayed in the display unit 2061 because the calibration was not normally performed for the portion that the user's hand was touching. This leads to a situation where the touch-coordinate signal output unit 2064 outputs the touch-manipulation coordinate signal representing the detected touch-manipulation coordinates, and the touch-coordinate monitoring unit 207 detects that touch-manipulation coordinate signal. To address this situation, when detecting a touch-manipulation coordinate signal from the touch-coordinate signal output unit 2064 after calibration process is terminated and before the initial-menu window is displayed in the display unit 2061 (YES in S4), the touch-coordinate monitoring unit 207 determines the calibration of the touch panel 206 to be not normally performed. And it notifies the user to conduct a reactivation manipulation of the video processor 20 (S5) to reperform the calibration process. This notifying is performed in the form of an error message of for example “Please once turn off and again turn on the power without touching the touch panel” (reactivation-instruction message) displayed on the monitor 30 as illustrated in B of FIG. 3. An error message such as this may be displayed in for example the display unit 2061.

When the determination result is NO in S4 by contrast, the video processor 20 displays the initial-menu window in the display unit 2061 (S6).

When the initial-menu window is displayed in the display unit 2061, the touch-coordinate monitoring unit 207 determines whether or not the first touch-manipulation coordinate signal has been detected from the touch-coordinate signal output unit 2064 after the display of the initial-menu window (S7).

When the determination result is NO in S7, this determination is repeated.

When the determination result is YES in S7 by contrast, the touch-coordinate monitoring unit 207 gives a calibration performing instruction to the calibration performing unit 205 (S8).

The calibration performing unit 205 reperforms a calibration process in accordance with the calibration performing instruction of S8 (S9).

The processes in S7 through S9 are performed for the following reasons. In some cases, the calibration process of S3 is performed with the display unit 2061 of the touch panel 206 in a state in which it is touched by a user's finger for example as illustrated in A of FIG. 4, and thereafter the initial-menu window is displayed in the display unit 2061 with the state continuing as it is, as illustrated in B of FIG. 4. In that case, the finger touching the touch panel 206 does not move or cease to touch the touch panel 206 after the calibration process of S3 is performed and before the initial-menu window is displayed in the display unit 2061, and thus the determination result in S4 will not become YES. This means that the portion touched by the user's finger has not been calibrated normally. On the assumption of such a case, the touch-coordinate monitoring unit 207 unconditionally reperforms a calibration process (S8 and S9) when the touch-coordinate monitoring unit 207 detects a first touch-manipulation coordinate signal from the touch-coordinate signal output unit 2064 after the initial-menu window is displayed (the determination result is YES in S7). Note as described above that when a calibration process is performed with the touch panel 206 in a state in which it is touched by the user's finger, the state continues, and the user's finger ceases to touch the touch panel 206 after the initial-menu window is displayed, the touch-coordinate detection unit 2063 detects the coordinates of the portion touched by the user's finger as the touch-manipulation coordinates. Accordingly, a calibration process is reperformed when the user's finger ceases to touch the touch panel 206.

When S5 or S9 is terminated, this operation is terminated.

When the user performs a reactivation manipulation of the video processor 20 in response to the notifying of S5, the operation illustrated in FIG. 2 is performed.

As described above, even when a calibration process is performed with the touch panel 206 touched by a user's hand etc. and the touch panel 206 failed to be calibrated normally, the reperformance of the calibration process after the failure enables the touch panel 206 to be normally calibrated. Thereby, the user can always use the touch panel 206 that has been appropriately calibrated, according to the present embodiment.

In the present embodiment, the display unit 2061 may display a message such as for example “Don't touch the touch panel” as illustrated in FIG. 5 during the activation of the video processor 20 or at least while a calibration process is being performed in order to prevent the calibration process from being performed with the touch panel 206 touched by the user's hand etc.

The above embodiment just provides specific examples of the present invention for facilitating understanding of the invention, and the scope of the present invention is not limited to the embodiment. The present invention allows various modifications and changes without departing from the spirit of the present invention, which is defined in the claims.

What is claimed is:

1. A touch panel device comprising:
a capacitance touch panel;
a calibration performing unit configured to perform a first calibration process for adjusting a reference potential, which serves as a detection threshold for a touch manipulation on the touch panel, after a power source starts power supply;
a touch manipulation detection unit configured to become able to detect a touch manipulation on the touch panel after the first calibration process is completed; and
a touch manipulation monitoring unit configured to monitor detection of a touch manipulation in the touch manipulation detection unit after the first calibration process is completed, and to instruct the calibration performing unit to perform a second calibration process for adjusting the reference potential, when the touch manipulation detection unit detects a first touch manipulation, wherein
the calibration performing unit performs the second calibration process in accordance with the instruction of the touch manipulation monitoring unit.

2. The touch panel device according to claim 1, further comprising
a notification unit configured to notify a user to conduct a reactivation manipulation of the touch panel device when the touch manipulation detection unit detects a touch manipulation after the calibration performing unit performs the first calibration process and before reception of a touch manipulation on the touch panel starts.

3. The touch panel device according to claim 2, further comprising
a power source switch, wherein
the power source starts or stops power supply to the touch panel device in accordance with a manipulation by a user on the power source switch, and
the calibration performing unit starts performing the first calibration process in response to the power source starting the power supply.

4. The touch panel device according to claim 3, wherein
the reactivation manipulation is a manipulation of the power source switch for making the power source stop and start the power supply.

5. A process method for a touch panel device including a capacitance touch panel, the process method comprising:
performing a first calibration process for adjusting a reference potential, which serves as a detection threshold for a touch manipulation on the touch panel, after a power source starts power supply; and
monitoring detection of a touch manipulation after the first calibration process is completed, and performing a second calibration process for adjusting the reference potential for the touch panel when a first touch manipulation is detected on the touch panel.
